(19) United States
(12) Patent Application Publication
(10) Pub. No.: US 2004/0044603 A1
(43) Pub. Date: Mar. 4, 2004

(54) Electronic invoice processing system with boolean feature

(76) Inventors: Brenda L. Gordon-Ervin, (US); Michael Patrick Force, (US); Lisa Christine Batur, (US); Julie Violet Pierce, (US)

Correspondence Address: Grossman, Tucker, Perreault & Pfleger, PLLC, 55 South Commercial Street, Manchester, NH, 03101, US

(21) Appl. No.: 10/232,162

(22) Filed: Aug. 30, 2002

(51) Int. Cl. G06F 17/60

(52) U.S. Cl. 705/34

(57) ABSTRACT

A rules engine application for an electronic invoice processing system prompts a user to create a billing rule to aid in electronic invoice analysis includes the steps of: prompting the user to define a first portion of the rule having a first violation condition; prompting the user to define a second portion of the rule having a second violation condition; and prompting the user to select a first Boolean operator having a first logic operation to logically join the first portion and the second portion of the rule. A machine readable medium and related electronic invoice processing systems having such a machine readable medium that stores instructions for performing such functions are also provided.

### FIELD OF THE INVENTION

The present invention relates generally to an internet-based electronic invoice processing system, and in particular to such a system having a rules engine capable of enabling a user to construct complex rules with Boolean operators.

### BACKGROUND OF THE INVENTION

Various internet-based electronic invoice processing systems are known in the art whereby a vendor can electronically create and present a bill to a customer for review. Such systems may also incorporate electronic payment features. Such electronic systems have the advantage of displacing traditional paper-based billing and payment methods. As such, efficiencies can be realized for both a vendor and customer by avoiding associated manual work created by such traditional paper-based billing and processing methods.

When the vendor and customer are businesses conducting business-to-business transactions, for example, when the vendor is a law firm and the customer is a client corporation, complex billing rules are often negotiated and must be adhered to by the law firm. For instance, these rules may relate to a variety of matters including timekeeper rates and unit rates per various expense categories. The law firm should implement systems for generating its bills in compliance with the rules and the corporate client customer typically finds it useful to check each bill to assure the law firm has complied.

In prior art electronic invoice processing systems, a rules engine may not typically be provided, or if it is provided, it typically has limited functionality and flexibility. In general, a rules engine is a software application that applies particular rules to select invoices to aid a customer in invoice analysis and adjustment. Ideally, rules should be based on established billing practices and procedures between a particular vendor and customer. However, the unavailability or limited functionality of most rules engines has hampered their application. Accordingly, there is a need in the art for a flexible rules engine with enhanced features including the use of Boolean operators to allow formulation of complex rules.

### BRIEF SUMMARY OF THE INVENTION

A method of prompting a user to create a rule to aid in electronic invoice analysis consistent with the invention includes the steps of: prompting the user to define a first portion of the rule having a first violation condition; prompting the user to define a second portion of the rule having a second violation condition; and prompting the user to select a first Boolean operator having a first logic operation to logically join the first portion and the second portion of the rule.

A machine readable medium consistent with the invention whose contents cause a computer server system to perform a method of prompting a user to create a rule to aid in electronic invoice analysis, the method including the steps of: prompting the user to define a first portion of the rule having a first violation condition; prompting the user to define a second portion of the rule having a second violation condition; and prompting the user to select a first Boolean operator having a first logic operation to logically join the first portion and the second portion of the rule.

An electronic billing system consistent with the invention includes: a data center configured to receive an electronic invoice, the data center includes a data center computer server and a machine readable medium whose contents cause the data center computer system to perform a method of prompting a user to create a rule to aid in electronic invoice analysis comprising the steps of: prompting the user to define a first portion of the rule having a first violation condition; prompting the user to define a second portion of the rule having a second violation condition; and prompting the user to select a first Boolean operator having a first logic operation to logically join the first portion and the second portion of the rule.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of an electronic invoice processing system consistent with the invention;

FIG. 2 is an exemplary screen display that a user may see to create more complex rules using Boolean operators; and

FIG. 3 is a flow chart of an exemplary process enabling formulation of more complex rules using Boolean operators.

### DETAILED DESCRIPTION

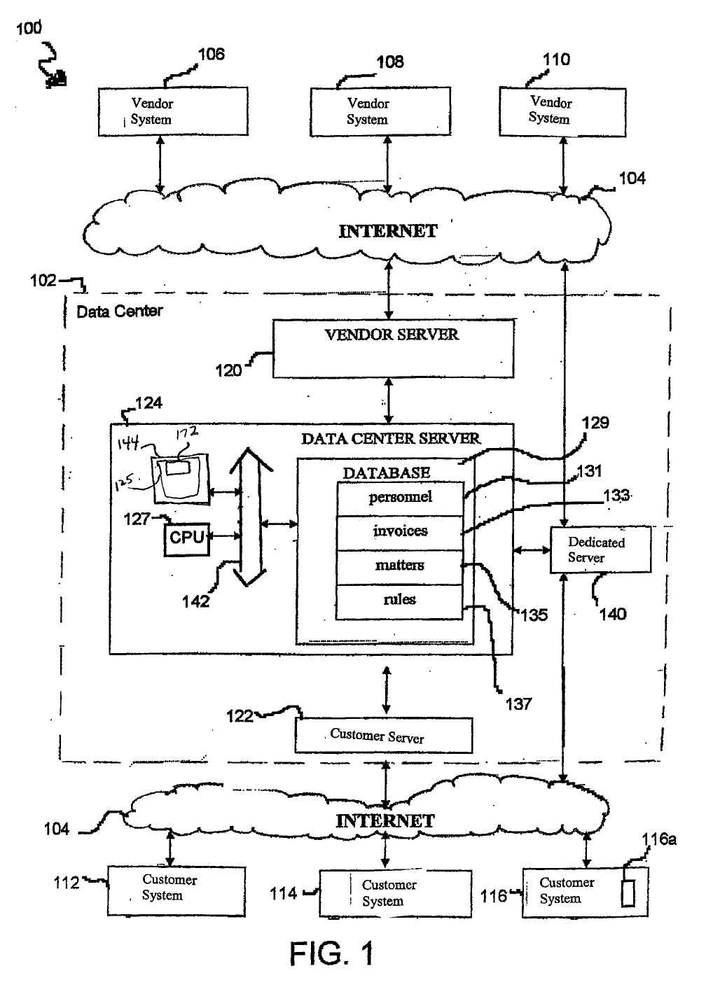

FIG. 1 illustrates a web-based electronic invoice processing system 100 consistent with the invention. In general, the system 100 includes a data center 102 coupled via the internet 104 to various vendor systems 106, 108, 110 and customer systems 112, 114, 116. The data center 102 serves as a centralized repository for storing, managing, and processing data related to invoice generation, analysis, and payment as further detailed herein. The data center 102 includes a vendor server 120, a customer server 122, a data center server 124, and a dedicated server 140. In one of many embodiments, the system 100 may be used as a legal e-billing system enabling a plurality of law firms (vendor systems) and their client corporations (customer systems) to engage in electronic invoice processing and payment.

In general, the system 100 permits vendor systems 106, 108, 110 to present invoices, in electronic form, to various customer systems 112, 114, 116, and allows customer systems 112, 114, 116 to automate a number of invoice review and processing operations as detailed further herein.

The vendor systems 106, 108, 110 and customer systems 112, 114, 116 represent parties that participate in the system 100. Each party may have one or more computer workstations having appropriate hardware and browser software, e.g., Netscape Navigator TM or Microsoft Internet Explorer TM, and/or direct real-time Transmission Control Protocol/Internet Protocol (TCP/IP), for permitting human users to send and receive data to the data center 102 and to control various operations of the data center 102 in real time and/or batch type transactions. To provide secure transmissions over the internet 104, the browser software should preferably have a minimum 128-bit encryption capability. As such, all files, e.g., invoice files, matter files, and timekeeper files, are encrypted when they are sent over the internet 104 to an associated server 120, 122.

Each vendor system 106, 108, 110 or customer system 112, 114, 116 may also have one or more associated servers, e.g., server 116a for customer system 116, that run associated applications. For instance, each vendor system 106, 108, 110 may have any one of a plurality of time and billing software systems, and each customer system 112, 114, 116 may have any one of a plurality of matter management systems or accounts payable systems.

In order to communicate and integrate with such outside systems of each vendor system and customer system, the system 100 may be further equipped with a dedicated server 140 that is configured to transfer and receive data to and from associated servers of vendors or customers using a predetermined communication protocol. For example, such a server 140 may be a File Transfer Protocol (FTP) server that can exchange files using FTP protocol to an associated server of any vendor systems 106, 108, 110 or customer systems 112, 114, 116.

For example, server 116a of customer system 116 may transfer matter management data from its matter management system to the server 140. The data center server 124 may then later accept such data for use it any of its processes. The data center server 124 may also transfer data, e.g., invoice data, to the server 140 so that the server 140 can later communicate such data to the accounts payable system of customer system 116 via server 116a. As such, the server 140 provides a way to integrate the data center 102 with disparate systems of any vendor or customer.

The vendor server 120 and customer server 122 are illustrated and described herein as separate server software applications operated on separate hardware systems for clarity of description. Those skilled in the art will recognize however, that such functionality for each could be combined on one server application or in multiple server applications operating on a single hardware system. Access to the servers 120, 122 by the vendor systems 106, 108, 110 and customer systems 112, 114, 116 may be through a variety of communication channels over the internet 104 such as point-to-point leased line/frame relay, public internet via an internet service provider, or a virtual private network (VPN) to name a few.

In addition, data transfers between vendor systems 106, 108, 110 and customer systems 112, 114, 116 to the data center server 124 may use a predetermined communication protocol as well so that the data content of the files is recognized by the data center server 124 and the “associated application” at the vendor systems 106, 108, 110 or customer systems 112, 114, 116. For instance, in transferring invoice data from a vendor system 106, 108, 110 to the data center 102 a standard format such as the LEDES™ electronic invoice standard coordinated by PriceWaterhouseCoopers may be utilized.

The vendor server 120 is a software application that provides services to other client software applications in a client/server relationship. In one instance, the vendor server 120 provides services to the vendor systems 106, 108, 110. In another instance, the vendor server 120 acts as a client in making requests to the data center server 124 which fulfills such requests. For instance, the data center server 124 may provide view matter, review invoices, and submit invoice transactions to the vendor server 120. The vendor server 120 builds a Hypertext Markup Language (HTML) or other graphical user interface (GUI) document in accordance therewith. A GUI document is then provided to the vendor system 106, 108, 110 which displays various GUI documents. Such GUI documents enable the user to perform a variety of functions such as viewing matters assigned to them, reviewing invoices, and submiting invoices and timekeepers.

Similar to the vendor server 120, the customer server 122 is a software application that provides services to other client software applications in a client/server relationship. In one instance, the customer server 122 provides services to the customer systems 112, 114, 116. In another instance, the customer server 122 acts as a client in making requests to the data center server 124 which fulfills such requests. The customer server 122 builds an HTML or other GUI document in accordance with such request. A GUI document is then provided to the customer system 112, 114, 116 which displays such documents. Such GUI documents enable a customer user to perform a variety of functions such as reviewing invoices and creating rules to help in analyzing and reviewing such invoices.

The data center server 124 of the data center 102 includes a processor 127 which operates data center server applications 125 that performs the main processing operations for the system 100. The data base server 124 also includes an extensive database 129 that contains aggregations of data records. Such data records relate to vendor systems 106, 108, 110, customer systems 112, 114, 116, and associated information. The database 129 is a relational database such as a DB2 database from IBM Corporation that can manage the large volumes of data to be stored and processed by the data center server 124. A standard user and application program interface to such a relational database is structured query language (SQL).

For clarity of description, some of the related aggregated data categories in the relational database are described herein as “data modules.” Some of the data modules include a personnel data module 131, an invoices data module 133, a matters data module 135, and a rules data module 137, to name several. In general, the personnel data module contains information about personnel of the customers 116, 118, 120 who are able to act upon invoices. The invoices data module 133 contains invoice related data submitted by the various vendors. The matters data module 135 contains basic information to identify and describe various matters. Finally, the rules data module 137 contains data relating to any rules defined by any customer 112, 114, 116. Each of these data modules may be implemented in one or more related database tables.

The rules engine 172 is one of the software applications 125 that is stored on a machine-readable media 144 of the data center server 124. This rules engine 172 performs functions that enable a user of the customer system 112, 114, 116 to create specific rules and store relevant data for such rules in the rules data module 137 that may then be later applied to particular customer-vendor relationships.

For instance, the data center server applications 125 including the rules engine 172 are software routines that may be stored on any variety of machine-readable media 144 for execution by the CPU 127. The processor 127 of the data center server 124 can be any type of processor capable of providing the speed and functionality required by embodiments of the invention. For example, the processor could be a processor from the Pentium® family of processors made by Intel Corporation.

The machine-readable media 144 can be any type of media capable of storing instructions adapted to be executed by the processor 127. Some examples of such media include, but are not limited to, system RAM, read only memory (ROM), programmable ROM, magnetic disk (e.g., floppy disk and hard disk drive), optical disk (e.g., CD/DVD ROM), and any other device that can store digital information. As used herein, the phrase “adapted to be executed by a processor” is meant to encompass instructions stored in compressed and/or encrypted format, as well as instructions that have to be compiled or installed by an installer before being executed by the processor. The processor 127 and machine-readable medium 144 may be part of various components of the data center 102 and data center server 124 where various combinations of machine-readable media may store combinations of the rules engine software which are accessible by the processor through various controllers.

Advantageously, a rules engine application 172 consistent with the invention is configured to enable a user to construct complex rules with Boolean operators. The rule engine 172 which may be stored on the machine-readable machine readable media 144 of the data center server contains appropriate code and instructions that communicate with the customer server 122. In accordance with such instructions, the customer server 122 builds and HTML or other GUI document that prompts or enables a user of the system to construct billing rules that are applied to selected invoices.

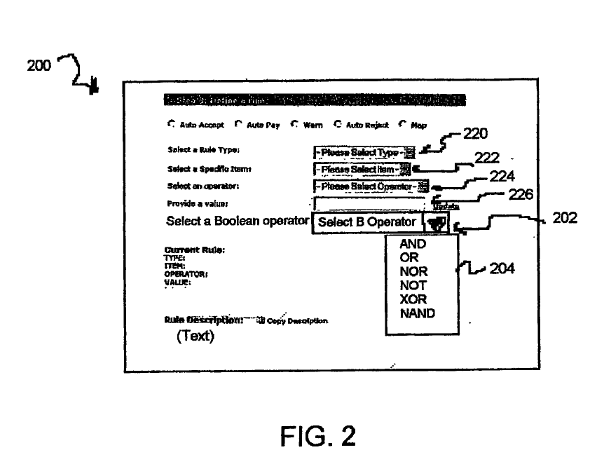

Turning to FIG. 2, such a screen display 200 that may be built by the customer server 122 based on instructions from the rules engine 172 is illustrated. Such a screen display 200 prompts the user to define rule conditions. Advantageously, such a screen display also provides an opportunity for a user to select a Boolean operator from the Boolean Operator block 202, which when selected creates a “drop down” Boolean menu 204 that includes the various Boolean operators that may be selected in creating a complex rule.

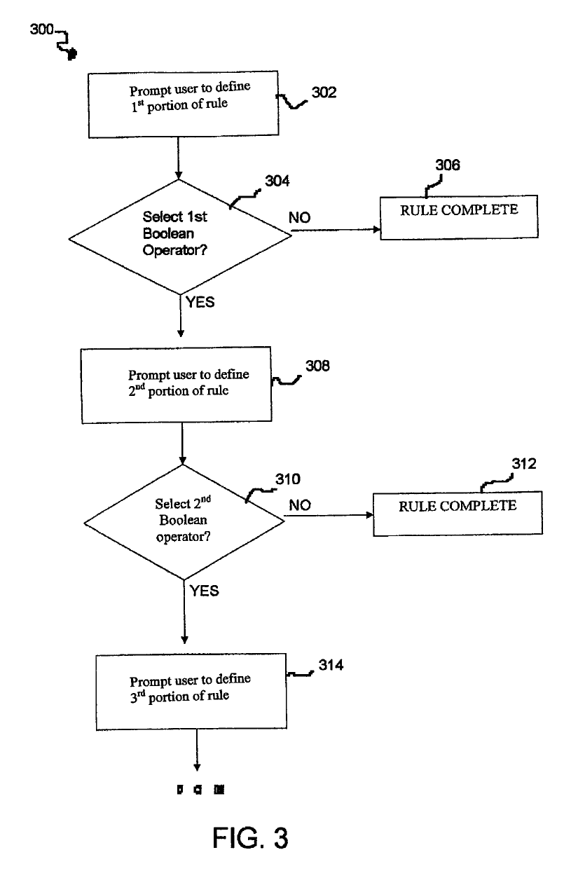

Turning to FIG. 3 in conjunction with FIG. 2, an exemplary process 300 that a rules engine 172 consistent with the invention takes to enable a user to create complex rules with Boolean operators is illustrated. The rules engine 172 first prompts a user to define a first portion of a rule 302. This may occur in any number of ways. For instance, the rules engine 172 may prompt a user to select a rule type 220 (e.g., rule runs against an invoice, line item, matter, or budget), then a specific item 220 which would vary according to the rule type 220 previously selected, then an operator 224 which would also vary according to the previous selection (e.g., greater than, less than, equal to, or not equal to, etc.), and finally a value 226 that would trigger the rule violation.

The rules engine 172 would then prompt a user to select a first Boolean operator 304. If such a Boolean operator is not selected, then the first portion of the rule is the completed rule 306 and the rules engine takes steps to store associated rule data and reference it in an appropriate table of the database 129 of the data center server 124.

If a first Boolean operator was selected by a user, then the rules engine would further prompt the user to define a second portion of the rule 308. This second portion of the rule could be defined as previously described with reference to the first portion of the rule. Once the second portion of the rule is completed, the rule engine 172 would enable the user to select a second Boolean operator 310.

If a second Boolean operator was not selected, the rule would be complete 312. Such a completed rule would contain the first portion of the rule and the second portion of the rule logically joined by the first Boolean operator from step 304.

If yet another Boolean operator was selected in step 310, the rules engine would prompt a customer to define a third portion of the rule 314. The rules engine continues to enable a user to select more Boolean operator to logically join further portions of the completed rule. As such, a rules engine consistent with the invention enables a user to create complex rules containing any number of Boolean operators to logically join an associated plurality of rule portions. A completed rule would be structured as below.

RULE=Action to take IF (first portion of rule violated) BOOLEAN OPERATOR1 (second portion of rule violated) BOOLEAN OPERATOR2 (third portion of rule violated) . . . BOOLEAN OPERATORN (nth portion of rule violated)

For example, a rule having three rule portions and two AND Boolean operators could be “Warn if the Uniform Task Based Management System (UTBMS) code equals L160 AND the description contains ‘Letter’ AND the units are greater than 0.2.” Of course, any variety of rules of varying complexity can be formed in the above manner having any plurality of rule portions and a corresponding plurality of different Boolean operators.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

What is claimed is:

1. A method of prompting a user to create a rule to aid in electronic invoice analysis comprising the steps of:
prompting said user to define a first portion of said rule having a first violation condition;
prompting said user to define a second portion of said rule having a second violation condition; and
prompting said user to select a first Boolean operator having a first logic operation to logically join said first portion and said second portion of said rule.

2. The method of claim 1, further comprising:
prompting said user to define a third portion of said rule; and
prompting said user to select a second Boolean operator having a second logic operation to logically join said first portion and said second portion of said rule to said third portion of said rule.

3. The method of claim 1, wherein said first Boolean operator is selected from the group consisting of: AND, OR, NOT, NOT, XOR, and NAND.

4. The method of claim 1, wherein said first Boolean operator is an AND operator.

5. The method of claim 4, wherein said rule is violated if said first condition and said second condition are violated.

6. The method of claim 1, wherein said first Boolean operator is an OR operator.

7. The method of claim 6, wherein said rule is violated if said first condition or said second condition are violated.

8. A machine readable medium whose contents cause a computer server system to perform a method of prompting a user to create a rule to aid in electronic invoice analysis comprising the steps of:
prompting said user to define a first portion of said rule having a first violation condition;
prompting said user to define a second portion of said rule having a second violation condition; and
prompting said user to select a first Boolean operator having a first logic operation to logically join said first portion and said second portion of said rule.

9. The machine readable medium of claim 8, wherein said method further comprises:
prompting said user to define a third portion of said rule; and
prompting said user to select a second Boolean operator having a second logic operation to logically join said first portion and said second portion of said rule to said third portion of said rule.

10. The machine readable medium of claim 8, wherein said first Boolean operator is selected from the group consisting of: AND, OR, NOT, NOT, XOR, and NAND.

11. The machine readable medium of claim 8, wherein said first Boolean operator is an AND operator.

12. The machine readable medium of claim 11, wherein said rule is violated if said first condition and said second condition are violated.

13. The machine readable medium of claim 8, wherein said first Boolean operator is an OR operator.

14. The machine readable medium of claim 13, wherein said rule is violated if said first condition or said second condition are violated.

15. An electronic billing system comprising:
a data center configured to receive an electronic invoice, said data center comprising a data center computer server and a machine readable medium whose contents cause said data center computer system to perform a method of prompting a user to create a rule to aid in electronic invoice analysis comprising the steps of:
prompting said user to define a first portion of said rule having a first violation condition;
prompting said user to define a second portion of said rule having a second violation condition; and
prompting said user to select a first Boolean operator having a first logic operation to logically join said first portion and said second portion of said rule.

16. The system of claim 15, wherein said method further comprises:
prompting said user to define a third portion of said rule; and
prompting said user to select a second Boolean operator having a second logic operation to logically join said first portion and said second portion of said rule to said third portion of said rule.

17. The system of claim 15, wherein said first Boolean operator is selected from the group consisting of: AND, OR, NOT, NOT, XOR, and NAND.

18. The system of claim 15, wherein said first Boolean operator is an AND operator.

19. The system of claim 18, wherein said rule is violated if said first condition and said second condition are violated.

20. The system of claim 15, wherein said first Boolean operator is an OR operator.

21. The system of claim 20, wherein said rule is violated if said first condition or said second condition are violated.
